(19) United States
(12) Patent Application Publication
(10) Pub. No.: US 2026/0286069 A1
(43) Pub. Date: Sep. 24, 2026

(54) POLYPROPYLENE (PP) - CACO3 MASTERBATCH IN FIBERS

(71) Applicant: OMYA INTERNATIONAL AG, Oftringen (CH)

(72) Inventors: Barbara BONAVOGLIA, Zurich (CH); Martin BRUNNER, Wallbach (CH); Christophe René Pierre ROUX, Lyon (FR); Claes Gustav JANNERFELDT, Arzier-Le Muids (CH)

(73) Assignee: OMYA INTERNATIONAL AG, Oftringen (CH)

(21) Appl. No.: 19/477,860

(22) PCT Filed: Apr. 25, 2024
(86) PCT No.: PCT/EP2024/061437

§ 371 Date: Oct. 23, 2025

(30) Foreign Application Priority Data
Apr. 28, 2023 (EP) 23170726.6

(51) Int. Cl. C08J 3/22; C08K 3/26; D01F 8/14; D04H 1/435

(52) U.S. Cl. CPC C08J 3/22; C08K 3/26; D01F 8/14; D04H 1/435; C08J 2323/12; C08K 2003/265; D10B 2331/04

(57) ABSTRACT

The present invention relates to a polypropylene-based masterbatch comprising from 15 to 35 wt.-%, based on the total weight of the polypropylene-based masterbatch, of a propylene polymer having a melt flow rate MFR (230° C., 2.16 kg), measured according to ISO 1133, in the range from 15 to 50 g/10 min, and from 65 to 85 wt.-%, based on the total weight of the polypropylene-based masterbatch, of a surface-treated filler material product comprising at least one ground calcium carbonate-comprising filler material, a polyester fiber composition comprising the polypropylene-based masterbatch, polyester nonwoven or filament formed from the polyester fiber composition, a process for preparing a polyester nonwoven or filament as well as the use of a polypropylene-based masterbatch in the production of a polyester nonwoven or filament and an article formed from a polyester nonwoven or filament.

The present invention relates to a polypropylene-based masterbatch comprising from 15 to 35 wt.-%, based on the total weight of the polypropylene-based masterbatch, of a propylene polymer having a melt flow rate MFR (230° C., 2.16 kg), measured according to ISO 1133, in the range from 15 to 50 g/10 min, and from 65 to 85 wt.-%, based on the total weight of the polypropylene-based masterbatch, of a surface-treated filler material product comprising at least one ground calcium carbonate-comprising filler material, a polyester fiber composition comprising the polypropylene-based masterbatch, polyester nonwoven or filament formed from the polyester fiber composition, a process for preparing a polyester nonwoven or filament as well as the use of a polypropylene-based masterbatch in the production of a polyester nonwoven or filament and an article formed from a polyester nonwoven or filament.

It is common in the art to add certain fillers to polymer compositions such as for polyester fibers. For example, fillers such as calcium carbonate-comprising filler material are added to polyester fibers in order to improve its performance and reduce its carbon footprint. This is typically done by using polyester-based masterbatches due to the intrinsic compatibility of the masterbatch polyester carrier resin with the fiber polyester resin.

However, polyester-based masterbatches are expensive and provide low filler loading, making their implementation in the market challenging. Different polymers have been tested as carrier material in masterbatches. For example, WO2005040257 A1 discloses a blend of polyester and ethylene-methylacrylate copolymer (EMA) used as compatibilizer to be able to produce fibers and films. However, EMA compatibilizers are very expensive and thus are not the solution of choice for the production of PET fibers. On the other hand, CN101392082 A refers to a polypropylene imitation jade color masterbatch comprising polypropylene grafted maleic anhydride as compatibilizer. CN109535565 A refers to a nanometer calcium carbonate functional masterbatch, where elastomers and bridging agents are added to compatibilize. CN113980298 A refers to an antistatic master batch comprising calcium carbonate with dimensions of <60 nm, which is further surface-treated with titanium composite coupling agents, whereby the carrier resin is a mixture of bisphenol A-type aromatic polycarbonate, high-density polyethylene and polybutylene terephthalate. However, polyolefin-based masterbatches are believed to be incompatible with polyester. Hence, it is also assumed that such masterbatches will not work in fiber spinning without the addition of expensive compatibilizers.

In view of this, there is an ongoing need for CaCO₃ masterbatches to be added to polyester during production of fibers or filaments.

Accordingly, it is an object of the present invention to provide a masterbatch comprising a calcium carbonate-comprising filler material that can be used during the production of polyester fibers or filaments. Furthermore, it is desirable that the masterbatch has a high filler loading capacity and can be used without the addition of expensive compatibilizers. Furthermore, it is desirable that the polyester fiber or nonwoven comprising the masterbatch has similar performance and processability than the performance and processability obtained for a polyester fiber or nonwoven comprising a polyester-based masterbatch.

The foregoing and other objects are solved by the subject-matter as defined in the independent claims. Advantageous embodiments of the present invention are defined in the corresponding subclaims.

According to one aspect of the present invention, a polypropylene-based masterbatch is provided comprising from 15 to 35 wt.-%, based on the total weight of the polypropylene-based masterbatch, of a propylene polymer having a melt flow rate MFR (230° C., 2.16 kg), measured according to ISO 1133, in the range from 15 to 50 g/10 min, and from 65 to 85 wt.-%, based on the total weight of the polypropylene-based masterbatch, of a surface-treated filler material product comprising at least one ground calcium carbonate-comprising filler material having a weight median particle size d₅₀ in the range from 0.5 to 2.5 μm, measured by the sedimentation method, and a top cut particle size d₉₈, measured by the sedimentation method, of ≤9 μm.

According to one embodiment, the propylene polymer is a random propylene copolymer or a propylene homopolymer, and/or the propylene polymer has
a) a melt flow rate MFR (230° C., 2.16 kg), measured according to ISO 1133, in the range from 20 to 40 g/10 min and most preferably in the range from 22 to 37 g/10 min, and/or
b) a density, measured according to ISO 1183-1, equal or below 0.910 g/cm³, more preferably, the density is equal or above 0.850 g/cm³, and most preferably in the range from 0.850 to 0.910 g/cm³.

According to another embodiment, the ground calcium carbonate-comprising filler material is selected from the group comprising marble, chalk, dolomite, limestone, and mixtures thereof, most preferably the ground calcium carbonate-comprising filler material is marble.

According to yet another embodiment, the surface-treated filler material product, i.e. the surface-treated ground calcium carbonate-comprising filler material, comprises a treatment layer on the surface of the at least one ground calcium carbonate-comprising filler material comprising
i. at least one mono-substituted succinic anhydride consisting of succinic anhydride mono-substituted with a group selected from a linear, branched, aliphatic and cyclic group having a total amount of carbon atoms from at least C2 to C30 in the substituent and/or salts thereof, and/or
ii. at least one saturated or unsaturated aliphatic linear or branched carboxylic acid and/or salts thereof, preferably at least one aliphatic carboxylic acid having a total amount of carbon atoms from C4 to C24 and/or salts thereof.

According to one embodiment, the surface-treated filler material product, i.e. the surface-treated ground calcium carbonate-comprising filler material, comprises the treatment layer in an amount of from 0.1 to 3 wt.-%, based on the total dry weight of the at least one ground calcium carbonate-comprising filler material.

According to another embodiment, the surface-treated filler material product, i.e. the surface-treated ground calcium carbonate-comprising filler material, has a weight median particle size d₅₀, measured by the sedimentation method, in the range from 1.0 to 2.2 μm, preferably from 1.5 to 2.2 μm, and a top cut particle size d₉₈, measured by the sedimentation method, of ≤7.5 μm, and/or a specific surface area (BET) of from 0.5 to 150 m²/g as measured using nitrogen and the BET method according to ISO 9277:2010, preferably from 1 to 80 m²/g, more preferably from 2 to 75 m²/g, even more preferably from 2 to 40 m²/g, still more preferably from 3 to 25 m²/g, and most preferably from 3 to 15 m²/g, and/or a moisture, measured according to ISO 787/2, of ≤0.25 wt.-%, based on the total weight of the at least one surface-treated filler material product.

According to yet another embodiment, the polypropylene-based masterbatch comprises the propylene polymer in an amount ranging from 28 to 32 wt.-%, based on the total weight of the polypropylene-based masterbatch, and the surface-treated filler material product in an amount ranging from 68 to 72 wt.-%, based on the total weight of the polypropylene-based masterbatch.

According to one embodiment, the polypropylene-based masterbatch is free of polymeric materials differing from the propylene polymer in an amount of equal to or above 5 wt.-%, based on the total weight of the polypropylene-based masterbatch, and/or the polypropylene-based masterbatch is free of filler materials differing from the surface-treated filler material product, in an amount of equal to or above 5 wt.-%, based on the total weight of the polypropylene-based masterbatch.

According to a further aspect of the present invention, a polyester fiber composition is provided comprising from 86 to 99.3 wt.-%, preferably from 90 to 96.5 wt.-%, and most preferably from 92 to 94 wt.-%, based on the total weight of the polyester fiber composition, of a polyester resin having an intrinsic viscosity, measured according to ISO 1628-5, in the range from 0.6 to 0.8 dl/g, and from 0.7 to 14 wt.-%, preferably from 3.5 to 10 wt.-% and most preferably from 6 to 8 wt.-%, based on the total weight of the polyester fiber composition, of the polypropylene-based masterbatch as defined herein.

According to one embodiment, the polyester fiber composition comprises the surface-treated filler material product, i.e. the surface-treated ground calcium carbonate-comprising filler material, in an amount ranging from 0.5 to 10 wt.-%, preferably from 2 to 8 wt.-% and most preferably from 4 to 6 wt.-%, based on the total weight of the polyester fiber composition.

According to another embodiment, the polyester resin consists of one or more saturated polyester resin(s) selected from the group comprising polylactic acid, polylactic acid-based polymer, aliphatic polyester such as polyhydroxyalkanoates, e.g. polyhydroxybutyrate, poly-3-hydroxybutyrate (P3HB), polyhydroxyvalerate, polyhydroxybutyrate-polyhydroxyvalerate copolymer, poly(3-hydroxybutyrate-co-3-hydroxyvalerate); polyethylene terephthalate (PET), polybutylene terephthalate (PBT), polybutyrate-adipate-terephthalate (PBAT), polyglycolide, poly(dioxanone) and mixtures thereof, preferably the polyester resin is polyethylene terephthalate (PET)

According to still a further aspect of the present invention, a polyester nonwoven or filament formed from the polyester fiber composition defined herein is provided.

According to another aspect of the present invention, a process for preparing a polyester nonwoven or filament as defined herein is provided, wherein the process comprises the steps of
a) providing a polyester resin in an amount ranging from 86 to 99.3 wt.-%, preferably from 90 to 96.5 wt.-%, and most preferably from 92 to 94 wt.-%, based on the total weight of the polyester product, the polyester resin having an intrinsic viscosity, measured according to ISO 1628-5, in the range from 0.6 to 0.8 dl/g,
b) providing a polypropylene-based masterbatch in an amount ranging from 0.7 to 14 wt.-%, preferably from 3.5 to 10 wt.-% and most preferably from 6 to 8 wt.-%, based on the total weight of the polyester product,
c) contacting the a polyester resin of step a) and the polypropylene-based masterbatch of step b) for obtaining a polyester fiber composition, and
d) forming the polyester fiber composition obtained in step c) such that a polyester nonwoven or filament is obtained.

According to still another aspect of the present invention, the use of a polypropylene-based masterbatch in the production of a polyester nonwoven or filament is provided, the polypropylene-based masterbatch comprising from 15 to 35 wt.-%, based on the total weight of the polypropylene-based masterbatch, of a propylene polymer having a melt flow rate MFR (230° C., 2.16 kg), measured according to ISO 1133, in the range from 15 to 50 g/10 min, and from 65 to 85 wt.-%, based on the total weight of the polypropylene-based masterbatch, of a surface-treated filler material product comprising at least one ground calcium carbonate-comprising filler material having a weight median particle size d₅₀, measured by the sedimentation method, in the range from 0.5 to 2.5 μm, and a top cut particle size d₉₈, measured by the sedimentation method, of ≤9 μm.

According to still a further aspect of the present invention, an article formed from a polyester nonwoven or filament as defined herein is provided, preferably the article is selected from the group comprising hygiene products, medical and healthcare products, wipes such as refreshing wipes or cleaning wipes, tissue products, upholstery, geotextile products, filter products, agriculture and horticulture products, clothing, footwear and baggage products, household and industrial products, packaging products, construction products, automotive parts, bottles, cups, and the like.

It should be understood that for the purpose of the present invention, the following terms have the following meaning:

The term “polypropylene-based masterbatch” (= or “masterbatch”) in the meaning of the present invention relates to a composition with a relatively high filler content, that means ≥65 wt.-% (based on the total weight of the masterbatch). A “masterbatch” may be added to an unfilled or lowly filled polyester resin during processing in order to achieve higher filler contents.

The term “copolymer” as used herein refers to a polymer derived from more than one species of monomer. Copolymers that are obtained by copolymerization of two monomer species may also be termed bipolymers, those obtained from three monomers terpolymers, those obtained from four monomers quaterpolymers, etc. (cf. IUPAC Compendium of Chemical Terminology 2014, “copolymer”). Accordingly, the term “homopolymer” refers to a polymer derived substantially from one species of monomer.

The term “surface-treated” in the meaning of the present invention refers to a material which has been contacted with a surface treatment agent such as to obtain a coating layer on at least a part of the surface of the material.

The “particle size” of particulate materials is described herein by its weight-based distribution of particle sizes dx. Therein, the value dx represents the diameter relative to which x % by weight of the particles have diameters less than dx. This means that, for example, the d₂₀ value is the particle size at which 20 wt.-% of all particles are smaller than that particle size. The d₅₀ value is thus the weight median particle size, i.e. 50 wt.-% of all particles are smaller than this particle size. For the purpose of the present invention, the particle size is specified as weight median particle size d₅₀(wt) unless indicated otherwise. Particle sizes were determined by using a Sedigraph™ 5120 instrument of Micromeritics Instrument Corporation. The method and the instrument are known to the skilled person and are commonly used to determine the particle size of fillers and pigments. The measurements were carried out in an aqueous solution of 0.1 wt.-% Na₄P₂O₇.

The “specific surface area” (expressed in m²/g) of a material as used throughout the present document can be determined by the Brunauer Emmett Teller (BET) method with nitrogen as adsorbing gas and by use of a ASAP 2460 instrument from Micromeritics. The method is well known to the skilled person and defined in ISO 9277:2010. Samples are conditioned at 100° C. under vacuum for a period of 30 min prior to measurement. The total surface area (in m²) of said material can be obtained by multiplication of the specific surface area (in m²/g) and the mass (in g) of the material.

Where an indefinite or definite article is used when referring to a singular noun, e.g., “a”, “an” or “the”, this includes a plural of that noun unless anything else is specifically stated.

Where the term “comprising” is used in the present description and claims, it does not exclude other elements. For the purposes of the present invention, the term “consisting of” is considered to be a preferred embodiment of the term “comprising”. If hereinafter a group is defined to comprise at least a certain number of embodiments, this is also to be understood to disclose a group, which preferably consists only of these embodiments.

Terms like “obtainable” or “definable” and “obtained” or “defined” are used interchangeably. This, for example, means that, unless the context clearly dictates otherwise, the term “obtained” does not mean to indicate that, for example, an embodiment must be obtained by, for example, the sequence of steps following the term “obtained” though such a limited understanding is always included by the terms “obtained” or “defined” as a preferred embodiment.

Whenever the terms “including” or “having” are used, these terms are meant to be equivalent to “comprising” as defined hereinabove.

The polypropylene-based masterbatch of the present invention comprises from 15 to 35 wt.-%, based on the total weight of the polypropylene-based masterbatch, of a propylene polymer having a melt flow rate MFR (230° C., 2.16 kg), measured according to ISO 1133, in the range from 15 to 50 g/10 min, and from 65 to 85 wt.-%, based on the total weight of the polypropylene-based masterbatch, of a surface-treated filler material product comprising at least one ground calcium carbonate-comprising filler material having a weight median particle size d₅₀ in the range from 0.5 to 2.5 μm, measured by the sedimentation method, and a top cut particle size d₉₈, measured by the sedimentation method, of ≤9 μm.

In the following, preferred embodiments of the inventive products will be set out in more detail. It is to be understood that these embodiments and details also apply to the inventive methods for their preparation and their uses described herein.

### The Polypropylene-Based Masterbatch

The polypropylene-based masterbatch comprises from 15 to 35 wt.-%, based on the total weight of the polypropylene-based masterbatch, of a propylene polymer having a melt flow rate MFR (230° C., 2.16 kg), measured according to ISO 1133, in the range from 15 to 50 g/10 min.

The propylene polymer can be a propylene copolymer or a propylene homopolymer.

In case the propylene polymer is a propylene copolymer, the propylene copolymer is preferably a random propylene copolymer.

In one embodiment, the propylene copolymer, preferably the random propylene copolymer, comprises monomers copolymerizable with propylene, for example comonomers such as ethylene and/or C₄ to C₈ α-olefins, in particular ethylene and/or C₄ to C₈ α-olefins, e.g. 1-butene and/or 1-hexene. Preferably, the propylene polymer, preferably the random propylene copolymer, comprises, especially consists of, monomers copolymerizable with propylene from the group consisting of ethylene, 1-butene and 1-hexene. More specifically, the propylene polymer, preferably the random propylene copolymer, comprises-apart from propylene-units derivable from ethylene and/or 1-butene. In a preferred embodiment, the propylene copolymer, preferably the random propylene copolymer, comprises units derivable from ethylene and propylene only.

The term “propylene copolymer” relates to a propylene copolymer, preferably a random propylene copolymer, having preferably a comonomer content in the range of more than 1.0 to 10.0 wt.-%, more preferably in the range of more than 1.5 to 9.0 wt.-%, yet more preferably in the range of 2.0 to 8.0 wt.-%, based on the total weight of the propylene copolymer, preferably the random propylene copolymer.

The propylene copolymer is preferably a random propylene copolymer. The term “random” indicates that the comonomers of the propylene copolymer are randomly distributed within the copolymers. The term random is understood according to IUPAC (Glossary of basic terms in polymer science; IUPAC recommendations 1996).

The term “propylene homopolymer” relates to a polypropylene that consists substantially, i.e. of more than 99.0 wt.-% of, preferably of more than 99.2 wt.-%, even more preferably of more than 99.5 wt.-%, still more preferably of at least 99.8 wt.-%, based on the total weight of the propylene homopolymer, of propylene units. In a preferred embodiment, only propylene units in the propylene homopolymer are detectable.

In a preferred embodiment, the propylene polymer is a propylene homopolymer.

The propylene polymer, preferably the propylene homopolymer, can be unimodal or multimodal, like bimodal. However, it is preferred that the propylene polymer, preferably the propylene homopolymer is unimodal.

It has been found out that the propylene polymer, preferably the propylene homopolymer, must have a specific melt flow rate MFR (230° C., 2.16 kg), measured according to ISO 1133, in the range from 15 to 50 g/10 min. For example, the propylene polymer has a melt flow rate MFR (230° C., 2.16 kg), measured according to ISO 1133, in the range from 20 to 40 g/10 min and most preferably in the range from 22 to 37 g/10 min.

It is appreciated that the propylene polymer, preferably the propylene homopolymer, has a xylene cold soluble (XCS) content in the range from 1.0 to 3.5 wt.-%, preferably in the range from 1.5 to 3.0 wt.-%, based on the total weight of the propylene polymer.

It is further preferred that the propylene polymer has a relatively high melting temperature Tₘ. For example, the propylene polymer has a melting temperature Tₘ measured according to ISO11357-3 in the range from 130 to 170° C., preferably in the range from 135 to 168° C. For example, if the propylene polymer is a propylene homopolymer, the propylene homopolymer has a melting temperature Tₘ measured according to ISO11357-3 in the range from 155 to 170° C., preferably in the range from 160 to 168° C. Alternatively, if the propylene polymer is a propylene copolymer, preferably a random propylene copolymer, the propylene copolymer has a melting temperature Tₘ measured according to ISO11357-3 in the range from 130 to 145° C., preferably in the range from 135 to 140° C.

Additionally or alternatively, the propylene polymer, preferably the propylene homopolymer, has a density, measured according to ISO 1183-1, equal or below 0.910 g/cm³, more preferably the density is equal or above 0.850 g/cm³, and most preferably in the range from 0.850 to 0.910 g/cm³. For example, the propylene polymer, preferably the propylene homopolymer, has a density, measured according to ISO 1183-1, in the range from 0.870 to 0.910 g/cm³, more preferably in the range from 0.890 to 0.910 g/cm³ and most preferably in the range from 0.900 to 0.910 g/cm³.

In a preferred embodiment, the propylene polymer, preferably the propylene homopolymer, thus has
a) a melt flow rate MFR (230° C., 2.16 kg), measured according to ISO 1133, in the range from 20 to 40 g/10 min and most preferably in the range from 22 to 37 g/10 min, and/or
b) a density, measured according to ISO 1183-1, equal or below 0.910 g/cm³, more preferably the density is equal or above 0.850 g/cm³, and most preferably in the range from 0.850 to 0.910 g/cm³.

For example, the propylene polymer, preferably the propylene homopolymer, has
a) a melt flow rate MFR (230° C., 2.16 kg), measured according to ISO 1133, in the range from 20 to 40 g/10 min and most preferably in the range from 22 to 37 g/10 min, and
b) a density, measured according to ISO 1183-1, equal or below 0.910 g/cm³, more preferably the density is equal or above 0.850 g/cm³, and most preferably in the range from 0.850 to 0.910 g/cm³.

In one embodiment, the propylene polymer, preferably the propylene homopolymer, has
a) a melt flow rate MFR (230° C., 2.16 kg), measured according to ISO 1133, in the range from 22 to 37 g/10 min, and
b) a density, measured according to ISO 1183-1, in the range from 0.850 to 0.910 g/cm³, e.g. in the range from 0.870 to 0.910 g/cm³, more preferably in the range from 0.890 to 0.910 g/cm³ and most preferably in the range from 0.900 to 0.910 g/cm³.

For example, the propylene polymer, preferably the propylene homopolymer, has
a) a melt flow rate MFR (230° C., 2.16 kg), measured according to ISO 1133, in the range from 22 to 37 g/10 min, and
b) a density, measured according to ISO 1183-1, in the range from 0.900 to 0.910 g/cm³.

In a preferred embodiment, the propylene polymer, preferably the propylene homopolymer, is polymerized in the presence of a Ziegler-Natta-catalyst.

Ziegler-Natta-catalysts and the polymers obtained by using such catalysts are very well known in the art and the skilled person is well aware of methods and conditions that may be used to prepare the polymers.

The polypropylene-based masterbatch of the present invention further comprises a surface-treated filler material product. The surface-treated filler material product comprises at least one calcium carbonate-comprising filler material. In particular, the surface-treated filler material product comprises at least one ground calcium carbonate-comprising filler material.

In one embodiment, the at least one ground calcium carbonate-comprising filler material is selected from the group comprising marble, chalk, dolomite, limestone, and mixtures thereof. Preferably, the ground calcium carbonate-comprising filler material is selected from the group comprising, preferably consisting of, marble, limestone and chalk. More preferably, the ground calcium carbonate-comprising filler material is selected from the group comprising, preferably consisting of, marble and chalk. For example, the ground calcium carbonate-comprising filler material is marble.

The term “ground calcium carbonate-comprising filler material” in the meaning of the present invention is a calcium carbonate source obtained from sedimentary sources, such as marble, limestone, dolomite, chalk and/or mixtures thereof, and processed through a wet and/or dry treatment such as grinding, screening and/or fractionating, for example, by a cyclone or classifier. The ground calcium carbonate-comprising filler material may comprise further components occurring in sedimentary sources such as magnesium carbonate, alumino silicate etc. Thus, it is appreciated that the term “ground” calcium carbonate-comprising filler material is not understood to refer to a calcium carbonate obtained by milling, but rather refers to the sedimentary origin of the calcium carbonate.

Preferably, the at least one ground calcium carbonate-comprising filler material is a sedimentary ground calcium carbonate-comprising filler material. The term “sedimentary” ground calcium carbonate-comprising filler material refers to calcium carbonate that is formed by the accumulation or deposition of calcium carbonate particles and subsequent cementation of the particles on the floor of oceans or other bodies of water at the earth's surface.

“Dolomite” in the meaning of the present invention is a calcium carbonate containing mineral, namely a carbonic calcium-magnesium-mineral, having the chemical composition of CaMg(CO₃)₂ (“CaCO₃·MgCO₃”). A dolomite mineral may contain at least 30.0 wt.-% MgCO₃, based on the total weight of dolomite, preferably more than 35.0 wt.-%, and more preferably more than 40.0 wt.-% MgCO₃.

In general, the grinding of a ground calcium carbonate-comprising filler material may be a dry or wet grinding step and may be carried out with any conventional grinding device, for example, under conditions such that comminution predominantly results from impacts with a secondary body, i.e. in one or more of: a ball mill, a rod mill, a vibrating mill, a roll crusher, a centrifugal impact mill, a vertical bead mill, an attrition mill, a pin mill, a hammer mill, a pulveriser, a shredder, a de-clumper, a knife cutter, or other such equipment known to the skilled man. In case the calcium carbonate-comprising filler material comprises a wet ground calcium carbonate-comprising filler material, the grinding step may be performed under conditions such that autogenous grinding takes place and/or by horizontal ball milling, and/or other such processes known to the skilled man. The wet processed ground calcium carbonate-comprising filler material thus obtained may be washed and dewatered by well-known processes, e.g. by flocculation, filtration or forced evaporation prior to drying. The subsequent step of drying (if necessary) may be carried out in a single step such as spray drying, or in at least two steps. It is also common that such a mineral material undergoes a beneficiation step (such as a flotation, bleaching or magnetic separation step) to remove impurities.

Contrary thereto, “precipitated calcium carbonate” (PCC) refers to a synthesized material, generally obtained by precipitation following reaction of carbon dioxide and calcium hydroxide in an aqueous, semi-dry or humid environment or by precipitation of calcium and carbonate ions, for example CaCl₂) and Na₂CO₃, out of solution. Further possible ways of producing PCC are the lime soda process, or the Solvay process in which PCC is a by-product of ammonia production. Precipitated calcium carbonate exists in three primary crystalline forms: calcite, aragonite and vaterite, and there are many different polymorphs (crystal habits) for each of these crystalline forms. Calcite has a trigonal structure with typical crystal habits such as scalenohedral (S-PCC), rhombohedral (R-PCC), hexagonal prismatic, pinacoidal, colloidal (C-PCC), cubic, and prismatic (P-PCC). Aragonite is an orthorhombic structure with typical crystal habits of twinned hexagonal prismatic crystals, as well as a diverse assortment of thin elongated prismatic, curved bladed, steep pyramidal, chisel shaped crystals, branching tree, and coral or worm-like form. Vaterite belongs to the hexagonal crystal system. The obtained PCC slurry can be mechanically dewatered and dried. PCCs are described, for example, in EP2447213 A1, EP2524898 A1, EP2371766 A1, EP1712597 A1, EP1712523 A1, or WO2013/142473 A1.

In view of this, the ground calcium carbonate-comprising filler material can be easily differentiated from precipitated calcium carbonate (PCC).

Furthermore, “modified calcium carbonate” (MCC) features a natural ground or precipitated calcium carbonate with an internal structure modification or a surface-reaction product, i.e. “surface-reacted calcium carbonate”. A “surface-reacted calcium carbonate” is a material comprising calcium carbonate and insoluble, preferably at least partially crystalline, calcium salts of anions of acids on the surface. Typically, the insoluble calcium salt extends from the surface of at least a part of the calcium carbonate. The calcium ions forming said at least partially crystalline calcium salt of said anion originate largely from the starting calcium carbonate material. MCCs are described, for example, in US20120031576 A1, WO2009074492 A1, EP2264109 A1, EP2070991 A1, or EP2264108 A1.

In view of this, the ground calcium carbonate-comprising filler material can be easily differentiated from modified calcium carbonate (MCC).

Thus, the ground calcium carbonate-comprising filler material can be easily differentiated from precipitated calcium carbonate (PCC) and modified calcium carbonate (MCC).

It is appreciated that the ground calcium carbonate-comprising filler material has a specific particle size distribution. In particular, the ground calcium carbonate-comprising filler material has a weight median particle size d₅₀ in the range from 0.5 to 2.5 μm, measured by the sedimentation method. For example, the ground calcium carbonate-comprising filler material has a weight median particle size d₅₀, measured by the sedimentation method, in the range from 1.0 to 2.2 μm, preferably from 1.5 to 2.2 μm.

Additionally, the ground calcium carbonate-comprising filler material has a top cut particle size d₉₈, measured by the sedimentation method, of ≤9 μm. For example, the ground calcium carbonate-comprising filler material has a top cut particle size d₉₈, measured by the sedimentation method, of ≤7.5 μm.

In a preferred embodiment, the ground calcium carbonate-comprising filler material has a weight median particle size d₅₀, measured by the sedimentation method, in the range from 1.0 to 2.2 μm and a top cut particle size d₉₈, measured by the sedimentation method, of ≤7.5 μm. For example, the ground calcium carbonate-comprising filler material has a weight median particle size d₅₀, measured by the sedimentation method, in the range from 1.5 to 2.2 μm and a top cut particle size d₉₈, measured by the sedimentation method, of ≤7.5 μm.

Additionally or alternatively, the ground calcium carbonate-comprising filler material has a specific surface area (BET) of from 0.5 to 150 m²/g as measured using nitrogen and the BET method according to ISO 9277:2010, preferably from 1 to 80 m²/g, more preferably from 2 to 75 m²/g, even more preferably from 2 to 40 m²/g, still more preferably from 3 to 25 m²/g, and most preferably from 3 to 15 m²/g. In a specifically preferred embodiment, the ground calcium carbonate-comprising filler material has a specific surface area (BET) of from 3 to 10 m²/g as measured using nitrogen and the BET method according to ISO 9277:2010.

In one embodiment, the ground calcium carbonate-comprising filler material has a weight median particle size d₅₀ in the range from 0.5 to 2.5 μm, measured by the sedimentation method, and a top cut particle size d₉₈, measured by the sedimentation method, of ≤9 μm and a specific surface area (BET) of from 0.5 to 150 m²/g as measured using nitrogen and the BET method according to ISO 9277:2010, preferably from 1 to 80 m²/g, more preferably from 2 to 75 m²/g, even more preferably from 2 to 40 m²/g, still more preferably from 3 to 25 m²/g, and most preferably from 3 to 15 m²/g, e.g. from 3 to 10 m²/g.

In a preferred embodiment, the ground calcium carbonate-comprising filler material has a weight median particle size d₅₀, measured by the sedimentation method, in the range from 1.0 to 2.2 μm and a top cut particle size d₉₈, measured by the sedimentation method, of ≤7.5 μm and a specific surface area (BET) of from 0.5 to 150 m²/g as measured using nitrogen and the BET method according to ISO 9277:2010, preferably from 1 to 80 m²/g, more preferably from 2 to 75 m²/g, even more preferably from 2 to 40 m²/g, still more preferably from 3 to 25 m²/g, and most preferably from 3 to 15 m²/g, e.g. from 3 to 10 m²/g. For example, the ground calcium carbonate-comprising filler material has a weight median particle size d₅₀, measured by the sedimentation method, in the range from 1.0 to 2.2 μm and a top cut particle size d₉₈, measured by the sedimentation method, of ≤7.5 μm and a specific surface area (BET) as measured using nitrogen and the BET method according to ISO 9277:2010 from 1 to 80 m²/g.

In particular, the ground calcium carbonate-comprising filler material has a weight median particle size d₅₀, measured by the sedimentation method, in the range from 1.5 to 2.2 μm and a top cut particle size d₉₈, measured by the sedimentation method, of ≤7.5 μm and a specific surface area (BET) of from 0.5 to 150 m²/g as measured using nitrogen and the BET method according to ISO 9277:2010, preferably from 1 to 80 m²/g, more preferably from 2 to 75 m²/g, even more preferably from 2 to 40 m²/g, still more preferably from 3 to 25 m²/g, and most preferably from 3 to 15 m²/g, e.g. from 3 to 10 m²/g. For example, the ground calcium carbonate-comprising filler material has a weight median particle size d₅₀, measured by the sedimentation method, in the range from 1.5 to 2.2 μm and a top cut particle size d₉₈, measured by the sedimentation method, of ≤7.5 μm and a specific surface area (BET) as measured using nitrogen and the BET method according to ISO 9277:2010 from 1 to 80 m²/g.

It is appreciated that the ground calcium carbonate-comprising filler material preferably has
i) a weight median particle size d₅₀ in the range from 0.5 to 2.5 μm, measured by the sedimentation method, preferably in the range from 1.0 to 2.2 μm, and most preferably from 1.5 to 2.2 μm, and
ii) a top cut particle size d₉₈, measured by the sedimentation method, of ≤9 μm, and most preferably of ≤7.5 μm, and/or
iii) a specific surface area (BET) of from 0.5 to 150 m²/g as measured using nitrogen and the BET method according to ISO 9277:2010, preferably from 1 to 80 m²/g.

For example, the ground calcium carbonate-comprising filler material has
i) a weight median particle size d₅₀ in the range from 0.5 to 2.5 μm, measured by the sedimentation method, preferably in the range from 1.0 to 2.2 μm, and most preferably from 1.5 to 2.2 μm, and
ii) a top cut particle size d₉₈, measured by the sedimentation method, of ≤9 μm, and most preferably of ≤7.5 μm, and
iii) a specific surface area (BET) of from 0.5 to 150 m²/g as measured using nitrogen and the BET method according to ISO 9277:2010, preferably from 1 to 80 m²/g.

In one embodiment, the ground calcium carbonate-comprising filler material has
i) a weight median particle size d₅₀ in the range from 1.0 to 2.2 μm, measured by the sedimentation method, and most preferably from 1.5 to 2.2 μm, and
ii) a top cut particle size d₉₈, measured by the sedimentation method, of ≤7.5 μm, and/or
iii) a specific surface area (BET) of from 0.5 to 150 m²/g as measured using nitrogen and the BET method according to ISO 9277:2010, preferably from 1 to 80 m²/g.

For example, the ground calcium carbonate-comprising filler material has
i) a weight median particle size d₅₀ in the range from 1.0 to 2.2 μm, measured by the sedimentation method, and most preferably from 1.5 to 2.2 μm, and
ii) a top cut particle size d₉₈, measured by the sedimentation method, of ≤7.5 μm, and
iii) a specific surface area (BET) of from 0.5 to 150 m²/g as measured using nitrogen and the BET method according to ISO 9277:2010, preferably from 1 to 80 m²/g.

In order to provide a masterbatch that works in a blend with a polyester resin for producing fibers or nonwovens, it is required that the masterbatch comprises a surface-treated filler material product comprising at least one ground calcium carbonate-comprising filler material.

That is to say, the at least one ground calcium carbonate-comprising filler material is surface treated with a surface-treatment agent.

Thus, the surface-treated filler material product comprises a treatment layer on the surface of the at least one ground calcium carbonate-comprising filler material. The treatment layer on the surface of the at least one ground calcium carbonate-comprising filler material preferably comprises
i. at least one mono-substituted succinic anhydride consisting of succinic anhydride mono-substituted with a group selected from a linear, branched, aliphatic and cyclic group having a total amount of carbon atoms from at least C2 to C30 in the substituent and/or salts thereof, and/or
ii. at least one saturated or unsaturated aliphatic linear or branched carboxylic acid and/or salts thereof, preferably at least one aliphatic carboxylic acid having a total amount of carbon atoms from C4 to C24 and/or salts thereof.

For example, the treatment layer on the surface of the at least one ground calcium carbonate-comprising filler material comprises
i. at least one mono-substituted succinic anhydride consisting of succinic anhydride mono-substituted with a group selected from a linear, branched, aliphatic and cyclic group having a total amount of carbon atoms from at least C2 to C30 in the substituent and/or salts thereof, or
ii. at least one saturated or unsaturated aliphatic linear or branched carboxylic acid and/or salts thereof, preferably at least one aliphatic carboxylic acid having a total amount of carbon atoms from C4 to C24 and/or salts thereof.

According to one embodiment of the present invention, the surface-treated filler material product comprises a treatment layer on the surface of the at least one ground calcium carbonate-comprising filler material comprising at least one mono-substituted succinic anhydride consisting of succinic anhydride mono-substituted with a group selected from a linear, branched, aliphatic and cyclic group having a total amount of carbon atoms from at least C2 to C30 in the substituent and/or salts thereof. Preferably, the surface-treated filler material product comprises a treatment layer on the surface of the at least one ground calcium carbonate-comprising filler material comprising at least one mono-substituted succinic anhydride consisting of succinic anhydride mono-substituted with a group being a linear aliphatic group having a total amount of carbon atoms from at least C2 to C30 in the substituent and/or salts thereof. Additionally or alternatively, the surface-treated filler material product comprises a treatment layer on the surface of the at least one ground calcium carbonate-comprising filler material comprising at least one mono-substituted succinic anhydride consisting of succinic anhydride mono-substituted with a group being a branched aliphatic group having a total amount of carbon atoms from at least C3 to C30 in the substituent and/or salts thereof. Additionally or alternatively, the surface-treated filler material product comprises a treatment layer on the surface of the at least one ground calcium carbonate-comprising filler material comprising at least one mono-substituted succinic anhydride consisting of succinic anhydride mono-substituted with a group being a cyclic aliphatic group having a total amount of carbon atoms from at least C5 to C30 in the substituent and/or salts thereof.

Accordingly, it should be noted that the at least one mono-substituted succinic anhydride may be one kind of mono-substituted succinic anhydride. Alternatively, the at least one mono-substituted succinic anhydride may be a mixture of two or more kinds of mono-substituted succinic anhydride. For example, the at least one mono-substituted succinic anhydride may be a mixture of two or three kinds of mono-substituted succinic anhydride, like two kinds of mono-substituted succinic anhydride.

In one embodiment of the present invention, the at least one mono-substituted succinic anhydride is one kind of mono-substituted succinic anhydride.

It is appreciated that the at least one mono-substituted succinic anhydride represents a surface treatment agent and consists of succinic anhydride mono-substituted with a group selected from any linear, branched, aliphatic, and cyclic group having a total amount of carbon atoms from C2 to C30 in the substituent.

In one embodiment of the present invention, the surface-treated filler material product comprises a treatment layer on the surface of the at least one ground calcium carbonate-comprising filler material comprising at least one mono-substituted succinic anhydride consisting of succinic anhydride mono-substituted with a group selected from a linear, branched, aliphatic, and cyclic group having a total amount of carbon atoms from C3 to C20 in the substituent. For example, the surface-treated filler material product comprises a treatment layer on the surface of the at least one ground calcium carbonate-comprising filler material comprising at least one mono-substituted succinic anhydride consisting of succinic anhydride mono-substituted with a group selected from a linear, branched, aliphatic, and cyclic group having a total amount of carbon atoms from C4 to C18 in the substituent. Preferably, the surface-treated filler material product comprises a treatment layer on the surface of the at least one ground calcium carbonate-comprising filler material comprising at least one mono-substituted succinic anhydride consisting of succinic anhydride mono-substituted with a group being a linear aliphatic group having a total amount of carbon atoms from C3 to C20, more preferably from C4 to C18, in the substituent and/or salts thereof. Additionally or alternatively, the surface-treated filler material product comprises a treatment layer on the surface of the at least one ground calcium carbonate-comprising filler material comprising at least one mono-substituted succinic anhydride consisting of succinic anhydride mono-substituted with a group being a branched aliphatic group having a total amount of carbon atoms from C3 to C20, more preferably from C4 to C18, in the substituent and/or salts thereof. Additionally or alternatively, the surface-treated filler material product comprises a treatment layer on the surface of the at least one ground calcium carbonate-comprising filler material comprising at least one mono-substituted succinic anhydride consisting of succinic anhydride mono-substituted with a group being a cyclic aliphatic group having a total amount of carbon atoms from C5 to C20, more preferably from C5 to C18 in the substituent and/or salts thereof.

In one embodiment of the present invention, the surface-treated filler material product comprises a treatment layer on the surface of the at least one ground calcium carbonate-comprising filler material comprising at least one mono-substituted succinic anhydride consisting of succinic anhydride mono-substituted with one group being a linear and aliphatic group having a total amount of carbon atoms from C2 to C30, preferably from C3 to C20 and most preferably from C4 to C18 in the substituent. Additionally or alternatively, the surface-treated filler material product comprises a treatment layer on the surface of the at least one ground calcium carbonate-comprising filler material comprising at least one mono-substituted succinic anhydride consisting of succinic anhydride mono-substituted with one group being a branched and aliphatic group having a total amount of carbon atoms from C3 to C30, preferably from C3 to C20 and most preferably from C4 to C18 in the substituent.

Thus, it is preferred that the surface-treated filler material product comprises a treatment layer on the surface of the at least one ground calcium carbonate-comprising filler material comprising at least one mono-substituted succinic anhydride consisting of succinic anhydride mono-substituted with one group being a linear or branched, alkyl group having a total amount of carbon atoms from C2 to C30, preferably from C3 to C20 and most preferably from C4 to C18 in the substituent.

For example, the surface-treated filler material product comprises a treatment layer on the surface of the at least one ground calcium carbonate-comprising filler material comprising at least one mono-substituted succinic anhydride consisting of succinic anhydride mono-substituted with one group being a linear alkyl group having a total amount of carbon atoms from C2 to C30, preferably from C3 to C20 and most preferably from C4 to C18 in the substituent. Additionally or alternatively, the surface-treated filler material product comprises a treatment layer on the surface of the at least one ground calcium carbonate-comprising filler material comprising at least one mono-substituted succinic anhydride consisting of succinic anhydride mono-substituted with one group being a branched alkyl group having a total amount of carbon atoms from C3 to C30, preferably from C3 to C20 and most preferably from C4 to C18 in the substituent.

In one embodiment of the present invention, the at least one mono-substituted succinic anhydride is at least one linear or branched alkyl mono-substituted succinic anhydride. For example, the at least one alkyl mono-substituted succinic anhydride is selected from the group comprising ethylsuccinic anhydride, propylsuccinic anhydride, butylsuccinic anhydride, triisobutyl succinic anhydride, pentylsuccinic anhydride, hexylsuccinic anhydride, heptylsuccinic anhydride, octylsuccinic anhydride, nonylsuccinic anhydride, decyl succinic anhydride, dodecyl succinic anhydride, hexadecanyl succinic anhydride, octadecanyl succinic anhydride, and mixtures thereof.

Accordingly, it is appreciated that, e.g., the term “butylsuccinic anhydride” comprises linear and branched butylsuccinic anhydride(s). One specific example of linear butylsuccinic anhydride(s) is n-butylsuccinic anhydride. Specific examples of branched butylsuccinic anhydride(s) are iso-butylsuccinic anhydride, sec-butylsuccinic anhydride and/or tert-butylsuccinic anhydride.

Furthermore, it is appreciated that, e.g., the term “hexadecanyl succinic anhydride” comprises linear and branched hexadecanyl succinic anhydride(s). One specific example of linear hexadecanyl succinic anhydride(s) is n-hexadecanyl succinic anhydride. Specific examples of branched hexadecanyl succinic anhydride(s) are 14-methylpentadecanyl succinic anhydride, 13-methylpentadecanyl succinic anhydride, 12-methylpentadecanyl succinic anhydride, 11-methylpentadecanyl succinic anhydride, 10-methylpentadecanyl succinic anhydride, 9-methylpentadecanyl succinic anhydride, 8-methylpentadecanyl succinic anhydride, 7-methylpentadecanyl succinic anhydride, 6-methylpentadecanyl succinic anhydride, 5-methylpentadecanyl succinic anhydride, 4-methylpentadecanyl succinic anhydride, 3-methylpentadecanyl succinic anhydride, 2-methylpentadecanyl succinic anhydride, 1-methylpentadecanyl succinic anhydride, 13-ethylbutadecanyl succinic anhydride, 12-ethylbutadecanyl succinic anhydride, 11-ethylbutadecanyl succinic anhydride, 10-ethylbutadecanyl succinic anhydride, 9-ethylbutadecanyl succinic anhydride, 8-ethylbutadecanyl succinic anhydride, 7-ethylbutadecanyl succinic anhydride, 6-ethylbutadecanyl succinic anhydride, 5-ethylbutadecanyl succinic anhydride, 4-ethylbutadecanyl succinic anhydride, 3-ethylbutadecanyl succinic anhydride, 2-ethylbutadecanyl succinic anhydride, 1-ethylbutadecanyl succinic anhydride, 2-butyldodecanyl succinic anhydride, 1-hexyldecanyl succinic anhydride, 1-hexyl-2-decanyl succinic anhydride, 2-hexyldecanyl succinic anhydride, 6,12-dimethylbutadecanyl succinic anhydride, 2,2-diethyldodecanyl succinic anhydride, 4,8,12-trimethyltridecanyl succinic anhydride, 2,2,4,6,8-pentamethylundecanyl succinic anhydride, 2-ethyl-4-methyl-2-(2-methylpentyl)-heptyl succinic anhydride and/or 2-ethyl-4,6-dimethyl-2-propylnonyl succinic anhydride.

Furthermore, it is appreciated that e.g. the term “octadecanyl succinic anhydride” comprises linear and branched octadecanyl succinic anhydride(s). One specific example of linear octadecanyl succinic anhydride(s) is n-octadecanyl succinic anhydride. Specific examples of branched hexadecanyl succinic anhydride(s) are 16-methylheptadecanyl succinic anhydride, 15-methylheptadecanyl succinic anhydride, 14-methylheptadecanyl succinic anhydride, 13-methylheptadecanyl succinic anhydride, 12-methylheptadecanyl succinic anhydride, 11-methylheptadecanyl succinic anhydride, 10-methylheptadecanyl succinic anhydride, 9-methylheptadecanyl succinic anhydride, 8-methylheptadecanyl succinic anhydride, 7-methylheptadecanyl succinic anhydride, 6-methylheptadecanyl succinic anhydride, 5-methylheptadecanyl succinic anhydride, 4-methylheptadecanyl succinic anhydride, 3-methylheptadecanyl succinic anhydride, 2-methylheptadecanyl succinic anhydride, 1-methylheptadecanyl succinic anhydride, 14-ethylhexadecanyl succinic anhydride, 13-ethylhexadecanyl succinic anhydride, 12-ethylhexadecanyl succinic anhydride, 11-ethylhexadecanyl succinic anhydride, 10-ethylhexadecanyl succinic anhydride, 9-ethylhexadecanyl succinic anhydride, 8-ethylhexadecanyl succinic anhydride, 7-ethylhexadecanyl succinic anhydride, 6-ethylhexadecanyl succinic anhydride, 5-ethylhexadecanyl succinic anhydride, 4-ethylhexadecanyl succinic anhydride, 3-ethylhexadecanyl succinic anhydride, 2-ethylhexadecanyl succinic anhydride, 1-ethylhexadecanyl succinic anhydride, 2-hexyldodecanyl succinic anhydride, 2-heptylundecanyl succinic anhydride, iso-octadecanyl succinic anhydride and/or 1-octyl-2-decanyl succinic anhydride.

In one embodiment of the present invention, the surface-treated filler material product comprises a treatment layer on the surface of the at least one ground calcium carbonate-comprising filler material comprising at least one alkyl mono-substituted succinic anhydride that is selected from the group comprising butylsuccinic anhydride, hexylsuccinic anhydride, heptylsuccinic anhydride, octylsuccinic anhydride, hexadecanyl succinic anhydride, octadecanyl succinic anhydride, and mixtures thereof.

In one embodiment of the present invention, the at least one mono-substituted succinic anhydride is one kind of alkyl mono-substituted succinic anhydride. For example, the one alkyl mono-substituted succinic anhydride is butylsuccinic anhydride. Alternatively, the one alkyl mono-substituted succinic anhydride is hexylsuccinic anhydride. Alternatively, the one alkyl mono-substituted succinic anhydride is heptylsuccinic anhydride or octylsuccinic anhydride. Alternatively, the one alkyl mono-substituted succinic anhydride is hexadecanyl succinic anhydride. For example, the one alkyl mono-substituted succinic anhydride is linear hexadecanyl succinic anhydride such as n-hexadecanyl succinic anhydride or branched hexadecanyl succinic anhydride such as 1-hexyl-2-decanyl succinic anhydride. Alternatively, the one alkyl mono-substituted succinic anhydride is octadecanyl succinic anhydride. For example, the one alkyl mono-substituted succinic anhydride is linear octadecanyl succinic anhydride such as n-octadecanyl succinic anhydride or branched octadecanyl succinic anhydride such as iso-octadecanyl succinic anhydride or 1-octyl-2-decanyl succinic anhydride.

In one embodiment of the present invention, the one alkyl mono-substituted succinic anhydride is butylsuccinic anhydride such as n-butylsuccinic anhydride.

In one embodiment of the present invention, the at least one mono-substituted succinic anhydride is a mixture of two or more kinds of alkyl mono-substituted succinic anhydrides. For example, the at least one mono-substituted succinic anhydride is a mixture of two or three kinds of alkyl mono-substituted succinic anhydrides.

According to another embodiment of the present invention, the surface-treated filler material product comprises a treatment layer on the surface of the at least one ground calcium carbonate-comprising filler material comprising at least one saturated or unsaturated aliphatic linear or branched carboxylic acid and/or salts thereof, preferably at least one aliphatic carboxylic acid having a total amount of carbon atoms from C4 to C24 and/or salts thereof, more preferably at least one aliphatic carboxylic acid having a total amount of carbon atoms from C12 to C20 and/or salts thereof, most preferably at least one aliphatic carboxylic acid having a total amount of carbon atoms from C16 to C18 and/or salts thereof.

The carboxylic acid in the meaning of the present invention may be selected from one or more linear chain, branched chain, saturated, or unsaturated and/or alicyclic carboxylic acids. Preferably, the aliphatic carboxylic acid is a monocarboxylic acid, i.e. the aliphatic carboxylic acid is characterized in that a single carboxyl group is present. Said carboxyl group is placed at the end of the carbon skeleton.

In one embodiment of the present invention, the aliphatic linear or branched carboxylic acid and/or salt thereof is selected from saturated unbranched carboxylic acids, preferably selected from the group of carboxylic acids consisting of pentanoic acid, hexanoic acid, heptanoic acid, octanoic acid, nonanoic acid, decanoic acid, undecanoic acid, lauric acid, tridecanoic acid, myristic acid, pentadecanoic acid, palmitic acid, heptadecanoic acid, stearic acid, nonadecanoic acid, arachidic acid, heneicosylic acid, behenic acid, tricosylic acid, lignoceric acid, their salts, their anhydrides and mixtures thereof.

In another embodiment of the present invention, the aliphatic linear or branched carboxylic acid and/or salts thereof is selected from the group consisting of octanoic acid, decanoic acid, lauric acid, myristic acid, palmitic acid, stearic acid, arachidic acid and mixtures thereof. Preferably, the aliphatic carboxylic acid is selected from the group consisting of myristic acid, palmitic acid, stearic acid, their salts, their anhydrides and mixtures thereof.

Preferably, the aliphatic carboxylic acid and/or salts thereof is stearic acid and/or a stearic acid salt.

Alternatively, the unsaturated aliphatic linear or branched carboxylic acid is preferably selected from the group consisting of myristoleic acid, palmitoleic acid, sapienic acid, oleic acid, elaidic acid, vaccenic acid, linoleic acid, α-linolenic acid, eicosapentaenoic acid, docosahexaenoic acid and mixtures thereof. More preferably, the unsaturated aliphatic linear or branched carboxylic acid selected from the group consisting of myristoleic acid, palmitoleic acid, sapienic acid, oleic acid, elaidic acid, vaccenic acid, linoleic acid, α-linolenic acid and mixtures thereof. Most preferably, the unsaturated aliphatic linear or branched carboxylic acid is oleic acid and/or linoleic acid, preferably oleic acid or linoleic acid, most preferably linoleic acid.

The surface-treated filler material product of the present invention is preferably formed in that the at least one ground calcium carbonate-comprising filler material and the surface treatment agent are provided in that the at least one ground calcium carbonate-comprising filler material is contacted with the at least one surface treatment agent such that a treatment layer comprising the surface treatment agent and/or salts thereof is/are formed on the surface of the at least one ground calcium carbonate-comprising filler material.

It is appreciated that the treatment layer on the surface of the at least one ground calcium carbonate-comprising filler material preferably comprises the surface treatment agent and/or salts thereof. That is, a chemical reaction may take place between the at least one ground calcium carbonate-comprising filler material and the surface treatment agent. In other words, the treatment layer formed on the surface of the at least one ground calcium carbonate-comprising filler material may comprises the surface treatment agent and/or salts thereof.

The term “salts” of the surface treatment agent refers to products obtained by contacting the at least one ground calcium carbonate-comprising filler material with the surface treatment agent. Said reaction products are formed between at least a part of the applied surface treatment agent and reactive molecules located at the surface of the at least one ground calcium carbonate-comprising filler material.

In one embodiment, the surface-treated filler material product comprises the treatment layer in an amount of from 0.1 to 3 wt.-%, based on the total dry weight of the at least one ground calcium carbonate-comprising filler material.

Methods for the surface treatment of fillers, are known to the skilled person, and are described, for example, in EP3192837 A1, EP2770017 A1, and WO2016023937.

It is appreciated that the above information concerning the weight median particle size d₅₀, the top cut particle size d₉₈ and the specific surface area (BET) also apply to the surface-treated filler material product, i.e. the surface-treated ground calcium carbonate-comprising filler material.

Additionally or alternatively, the surface-treated filler material product, i.e. the surface-treated ground calcium carbonate-comprising filler material, preferably has a low moisture content. In particular, the moisture content of the surface-treated ground calcium carbonate-comprising filler material is preferably of ≤0.25 wt.-%, based on the total weight of the at least one surface-treated ground calcium carbonate-comprising filler material, more preferably ≤0.2 wt.-%, even more preferably ≤0.15 wt.-%, and most preferably ≤0.1 wt.-%. Additionally or alternatively, the moisture content of the surface-treated ground calcium carbonate-comprising filler material is preferably ≥0.005 wt.-%, based on the total dry weight of the at least one surface-treated ground calcium carbonate-comprising filler material, more preferably ≥0.01 wt.-%, and most preferably ≥0.02 wt.-%.

In one embodiment, the moisture content of the surface-treated filler material product, i.e. the surface-treated ground calcium carbonate-comprising filler material, is preferably from 0.005 wt.-% to 0.25 wt.-%, based on the total dry weight of the at least one surface-treated ground calcium carbonate-comprising filler material, more preferably from 0.01 wt.-% to 0.2 wt.-%, even more preferably from 0.01 wt.-% to 0.15 wt.-%, and most preferably from 0.02 wt.-% to 0.1 wt.-%.

Thus, it is preferred that the surface-treated filler material product, i.e. the surface-treated ground calcium carbonate-comprising filler material, preferably has
i) a weight median particle size d₅₀ in the range from 0.5 to 2.5 μm, measured by the sedimentation method, preferably in the range from 1.0 to 2.2 μm, and most preferably from 1.5 to 2.2 μm, and
i) a top cut particle size d₉₈, measured by the sedimentation method, of ≤9 μm, and most preferably of ≤7.5 μm, and/or
iii) a specific surface area (BET) of from 0.5 to 150 m²/g as measured using nitrogen and the BET method according to ISO 9277:2010, preferably from 1 to 80 m²/g, more preferably from 2 to 75 m²/g, even more preferably from 2 to 40 m²/g, still more preferably from 3 to 25 m²/g, and most preferably from 3 to 15 m²/g, and/or
iv) a moisture, measured according to ISO 787/2, of ≤0.25 wt.-%, based on the total weight of the at least one surface-treated ground calcium carbonate-comprising filler material.

For example, the surface-treated filler material product, i.e. the surface-treated ground calcium carbonate-comprising filler material, has
i) a weight median particle size d₅₀ in the range from 0.5 to 2.5 μm, measured by the sedimentation method, preferably in the range from 1.0 to 2.2 μm, and most preferably from 1.5 to 2.2 μm, and
ii) a top cut particle size d₉₈, measured by the sedimentation method, of ≤9 μm, and most preferably of ≤7.5 μm, and
iii) a specific surface area (BET) of from 0.5 to 150 m²/g as measured using nitrogen and the BET method according to ISO 9277:2010, preferably from 1 to 80 m²/g, more preferably from 2 to 75 m²/g, even more preferably from 2 to 40 m²/g, still more preferably from 3 to 25 m²/g, and most preferably from 3 to 15 m²/g, and
iv) a moisture, measured according to ISO 787/2, of ≤0.25 wt.-%, based on the total weight of the at least one surface-treated ground calcium carbonate-comprising filler material.

In one embodiment, the surface-treated filler material product, i.e. the surface-treated ground calcium carbonate-comprising filler material, has
i) a weight median particle size d₅₀ in the range from 1.0 to 2.2 μm, measured by the sedimentation method, and most preferably from 1.5 to 2.2 μm, and
ii) a top cut particle size d₉₈, measured by the sedimentation method, of ≤7.5 μm, and/or
iii) a specific surface area (BET) of from 0.5 to 150 m²/g as measured using nitrogen and the BET method according to ISO 9277:2010, preferably from 1 to 80 m²/g, more preferably from 2 to 75 m²/g, even more preferably from 2 to 40 m²/g, still more preferably from 3 to 25 m²/g, and most preferably from 3 to 15 m²/g, and/or
iv) a moisture, measured according to ISO 787/2, of ≤0.25 wt.-%, based on the total weight of the at least one surface-treated ground calcium carbonate-comprising filler material.

For example, the surface-treated filler material product, i.e. the surface-treated ground calcium carbonate-comprising filler material, has
i) a weight median particle size d₅₀ in the range from 1.0 to 2.2 μm, measured by the sedimentation method, and most preferably from 1.5 to 2.2 μm, and
ii) a top cut particle size d₉₈, measured by the sedimentation method, of ≤7.5 μm, and
(ii) a specific surface area (BET) of from 0.5 to 150 m²/g as measured using nitrogen and the BET method according to ISO 9277:2010, preferably from 1 to 80 m²/g, more preferably from 2 to 75 m²/g, even more preferably from 2 to 40 m²/g, still more preferably from 3 to 25 m²/g, and most preferably from 3 to 15 m²/g, and
iv) a moisture, measured according to ISO 787/2, of ≤0.25 wt.-%, based on the total weight of the at least one surface-treated ground calcium carbonate-comprising filler material.

It is appreciated that the polypropylene-based masterbatch comprises the surface-treated filler material product in a high filler loading.

Thus, the polypropylene-based masterbatch comprises from 15 to 35 wt.-%, based on the total weight of the polypropylene-based masterbatch, of a propylene polymer having a melt flow rate MFR (230° C., 2.16 kg), measured according to ISO 1133, in the range from 15 to 50 g/10 min, and from 65 to 85 wt.-%, based on the total weight of the polypropylene-based masterbatch, of a surface-treated filler material product comprising at least one ground calcium carbonate-comprising filler.

For example, the polypropylene-based masterbatch comprises the propylene polymer in an amount ranging from 28 to 32 wt.-%, based on the total weight of the polypropylene-based masterbatch, and the surface-treated filler material product in an amount ranging from 68 to 72 wt.-%, based on the total weight of the polypropylene-based masterbatch.

It is preferred that the polypropylene-based masterbatch substantially consists of the propylene polymer having a melt flow rate MFR (230° C., 2.16 kg), measured according to ISO 1133, in the range from 15 to 50 g/10 min, and the surface-treated filler material product comprising at least one ground calcium carbonate-comprising filler.

However, it is possible that additives that are typically used in the product to be prepared may be added to the polypropylene-based masterbatch.

Thus, the polypropylene-based masterbatch is preferably free of polymeric materials differing from the propylene polymer in an amount of equal to or above 5 wt.-%, preferably of equal to or above 3 wt.-% and most preferably of equal to or above 1 wt.-%, based on the total weight of the polypropylene-based masterbatch.

Additionally or alternatively, the polypropylene-based masterbatch is preferably free of filler materials differing from the surface-treated filler material product, in an amount of equal to or above 5 wt.-%, based on the total weight of the polypropylene-based masterbatch.

In a preferred embodiment, the polypropylene-based masterbatch is free of polymeric materials differing from the propylene polymer in an amount of equal to or above 5 wt.-%, based on the total weight of the polypropylene-based masterbatch, or the polypropylene-based masterbatch is free of filler materials differing from the surface-treated filler material product, in an amount of equal to or above 5 wt.-%, based on the total weight of the polypropylene-based masterbatch.

Alternatively, the polypropylene-based masterbatch is free of polymeric materials differing from the propylene polymer in an amount of equal to or above 5 wt.-%, based on the total weight of the polypropylene-based masterbatch, and the polypropylene-based masterbatch is free of filler materials differing from the surface-treated filler material product, in an amount of equal to or above 5 wt.-%, based on the total weight of the polypropylene-based masterbatch.

Furthermore, it is preferred that the amount of materials in the polypropylene-based masterbatch differing from the propylene polymer and the surface-treated filler material product is equal to or below 10 wt.-%, preferably equal to or below 8 wt.-%, and most preferably equal to or below 5 wt.-%, based on the total weight of the polypropylene-based masterbatch.

The polypropylene-based masterbatch may comprise optional additives that are typically present in the products to be prepared. For example, the polypropylene-based masterbatch may comprise one or more additives selected from e.g. antioxidants, light stabilizers, optical brightener, blue dyes, antiblocking agents, white pigments, and mixtures thereof.

The polypropylene-based masterbatch is obtained by methods well known in the art and are typically used for the product to be prepared. The polypropylene-based masterbatch is preferably obtained by mixing and/or kneading the propylene polymer having a melt flow rate MFR (230° C., 2.16 kg), measured according to ISO 1133, in the range from 15 to 50 g/10 min and the surface-treated filler material product to form a mixture and continuously pelletizing the obtained mixture. For example, the polypropylene-based masterbatch is obtained by compounding the propylene polymer having a melt flow rate MFR (230° C., 2.16 kg), measured according to ISO 1133, in the range from 15 to 50 g/10 min and the surface-treated filler material product.

The propylene polymer having a melt flow rate MFR (230° C., 2.16 kg), measured according to ISO 1133, in the range from 15 to 50 g/10 min and the surface-treated filler material product, and, if present, optional additives, may be (pre)-mixed and/or kneaded by the use of a suitable mixer, e.g. a Henschel mixer, a super mixer, a tumbler type mixer or the like. The compounding step may be done with a suitable extruder, preferably by a twin screw extruder (co or counter-rotating) or by any other suitable continuous compounding equipment, e.g. a continuous co-kneader (Buss), a continuous mixer (Farrel Pomini), a ring extruder (Extricom) or the like. The continuous polymer mass from extrusion may be either pelletized by (hot cut) die face pelletizing with underwater pelletizing, eccentric pelletizing and water ring pelletizing or by (cold cut) strand pelletizing with underwater and conventional strand pelletizing to form the extruded polymer mass into pellets. In one embodiment, the polypropylene-based masterbatch is obtained by compounding the propylene polymer having a melt flow rate MFR (230° C., 2.16 kg), measured according to ISO 1133, in the range from 15 to 50 g/10 min and the surface-treated filler material product without a step of pre-mixing and/or pre-kneading. In this embodiment, the propylene polymer having a melt flow rate MFR (230° C., 2.16 kg), measured according to ISO 1133, in the range from 15 to 50 g/10 min and the surface-treated filler material product are subjected to the compounding, preferably in a twin screw extruder, via different hoppers. The continuous polymer mass obtained is then pelletized as described above.

Thus, the polypropylene-based masterbatch may be in form of pellets, beads, or granules.

It is appreciated that the polypropylene-based masterbatch is preferably in form of pellets.

The size and form of the pellets is in the ranges typically used for the products to be prepared. The skilled person may easily chose and adapt the size and form according to the specific need and compounding line used.

### Products and Processes

Another aspect of the present invention refers to a polyester fiber composition comprising from 86 to 99.3 wt.-%, preferably from 90 to 96.5 wt.-%, and most preferably from 92 to 94 wt.-%, based on the total weight of the polyester fiber composition, of a polyester resin having an intrinsic viscosity, measured according to ISO 1628-5, in the range from 0.6 to 0.8 dl/g, and from 0.7 to 14 wt.-%, preferably from 3.5 to 10 wt.-% and most preferably from 6 to 8 wt.-%, based on the total weight of the polyester fiber composition, of the polypropylene-based masterbatch.

With regard to the definition of the polypropylene-based masterbatch and preferred embodiments thereof, reference is made to the statements provided above when discussing the technical details of the polypropylene-based masterbatch of the present invention.

It is appreciated that the wording “polyester fiber composition” refers to a polyester composition suitable for the preparation of fibers, e.g. in form of a nonwoven or filament. More specifically, said wording refers to a polyester composition suitable for the preparation of polyester fibers, e.g. in form of a polyester nonwoven or filament. Thus, the fibers, e.g. in form of a polyester nonwoven or filament, are prepared from a polyester fiber composition comprising from 86 to 99.3 wt.-%, preferably from 90 to 96.5 wt.-%, and most preferably from 92 to 94 wt.-%, based on the total weight of the polyester fiber composition, of a polyester resin having an intrinsic viscosity, measured according to ISO 1628-5, in the range from 0.6 to 0.8 dl/g, and from 0.7 to 14 wt.-%, preferably from 3.5 to 10 wt.-% and most preferably from 6 to 8 wt.-%, based on the total weight of the polyester fiber composition, of the polypropylene-based masterbatch.

It should be noted that the polyester resin may be one kind of polyester resin. Alternatively, the polyester resin may be a mixture of two or more kinds of polyester resins. For example, the polyester resin may be a mixture of two or three kinds of polyester resins, like two kinds of polyester resins.

In one embodiment of the present invention, the polyester resin comprises, preferably consists of, one kind of polyester resin.

In general, the term “polyester” means a polymer obtained by the condensation polymerization, at least in part, of a diol and a dicarboxylic acid. As the dicarboxylic acid, terephthalic acid, isophthalic acid, phthalic acid, naphthalenedicarboxylic acid, adipic acid, or sebacic acid can be used. As the diol, ethylene glycol, trimethylene glycol, tetramethylene glycol, or cyclohexanedimethanol can be used. The term “polyester” also refers to a polymer made from lactic acid or from ring opening polymerization of the lactide (cyclic ester) or polymers by biosynthesis such as enzymatic processes.

Additionally or alternatively, the polyester resin may be a partially or fully biobased polyester resin, i.e. a polyester resin in which the monomers are derived from renewable biomass sources. Examples of monomers include those which can be produced by using bioderived compounds. For example, the monomers include but are not limited to ethylene glycol (EG), furandicarboxylic acid (FDCA), polyethylene furanoate (PEF), which can be produced by using fructose, and mixtures thereof. Further monomers which are suitable for preparing the biobased polyester are described in e.g. WO2014/100265 A1, which is thus herewith incorporated by reference.

Additionally or alternatively, the polyester resin is a PET recycling material such as PET bottle scrap from the PET recycling stream.

Thus, the polyester resin of the present invention preferably consists of one or more saturated polyester resins selected from the group comprising polylactic acid, polylactic acid-based polymer, aliphatic polyester such as polyhydroxyalkanoates, e.g. polyhydroxybutyrate, poly-3-hydroxybutyrate (P3HB), polyhydroxyvalerate, polyhydroxybutyrate-polyhydroxyvalerate copolymer, poly(3-hydroxybutyrate-co-3-hydroxyvalerate); polyethylene terephthalate (PET), polybutylene terephthalate (PBT), polybutyrate-adipate-terephthalate (PBAT), polyglycolide, poly(dioxanone) and mixtures thereof.

In one embodiment, the polyester resin is preferably polyethylene terephthalate (PET).

It is thus appreciated that the polyester resin is preferably a saturated polyester resin.

It is required that the polyester resin has an intrinsic viscosity, measured according to ISO 1628-5, in the range from 0.6 to 0.8 dl/g.

In general, the polyester resin may have a number average molecular weight Mn measured by gel permeation chromatography from 5 000 to 200 000 g/mol, preferably from 10 000 to 100 000 g/mol, and more preferably from 15000 to 80000 g/mol.

Additionally or alternatively, the polyester resin has a specific gravity measured according to ASTM D782 from 0.5 to 5, preferably from 0.7 to 4, and more preferably from 1 to 3.

Additionally or alternatively, the polyester resin has a glass transition temperature Tg measured by differential scanning calorimetry (DSC) in the range from 35 to 90° C., preferably from 40 to 70° C., and more preferably from 45 to 70° C.

In one embodiment, the polyester resin has a number average molecular weight Mn measured by gel permeation chromatography from 5 000 to 200 000 g/mol, preferably from 10 000 to 100 000 g/mol, and more preferably from 15000 to 80000 g/mol, or a specific gravity measured according to ASTM D782 from 0.5 to 5, preferably from 0.7 to 4, and more preferably from 1 to 3, or a glass transition temperature Tg measured by differential scanning calorimetry (DSC) in the range from 35 to 90° C., preferably from 40 to 70° C., and more preferably from 45 to 70° C.

Preferably, the polyester resin has a number average molecular weight Mn measured by gel permeation chromatography from 5 000 to 200 000 g/mol, preferably from 10 000 to 100 000 g/mol, and more preferably from 15000 to 80000 g/mol, and a specific gravity measured according to ASTM D782 from 0.5 to 5, preferably from 0.7 to 4, and more preferably from 1 to 3, and a glass transition temperature Tg measured by differential scanning calorimetry (DSC) in the range from 35 to 90° C., preferably from 40 to 70° C., and more preferably from 45 to 70° C.

It is appreciated that the polyester fiber composition comprises from 86 to 99.3 wt.-%, based on the total weight of the polyester fiber composition, of the polyester resin having an intrinsic viscosity, measured according to ISO 1628-5, in the range from 0.6 to 0.8 dl/g, and from 0.7 to 14 wt.-%, based on the total weight of the polyester fiber composition, of the polypropylene-based masterbatch.

Preferably, the polyester fiber composition comprises from 90 to 96.5 wt.-%, and most preferably from 92 to 94 wt.-%, based on the total weight of the polyester fiber composition, of the polyester resin having an intrinsic viscosity, measured according to ISO 1628-5, in the range from 0.6 to 0.8 dl/g, and from 3.5 to 10 wt.-% and most preferably from 6 to 8 wt.-%, based on the total weight of the polyester fiber composition, of the polypropylene-based masterbatch. Such amounts are specifically suitable to form a polyester nonwoven or filament from the polyester fiber composition.

It is preferred that the polypropylene-based masterbatch is added to the polyester resin such that a high filler load is achieved.

Thus, the polyester fiber composition preferably comprises the surface-treated filler material product in an amount ranging from 0.5 to 10 wt.-%, based on the total weight of the polyester fiber composition. For example, the polyester fiber composition preferably comprises the surface-treated filler material product in an amount ranging from 2 to 8 wt.-% and most preferably from 4 to 6 wt.-%, based on the total weight of the polyester fiber composition.

The polyester fiber composition may further comprise additives, such as colouring pigments, fibers, e.g. cellulose, glass or wood fibers, dyes, waxes, lubricants, oxidative- and/or UV-stabilizers, antioxidants and other fillers, such as carbon black, TiO₂, mica, clay, precipitated silica, talc or calcined kaolin.

According to one embodiment, the polyester fiber composition comprises a filler differing from the at least one ground calcium carbonate-comprising filler material having a weight median particle size d₅₀ in the range from 0.5 to 2.5 μm, measured by the sedimentation method, and a top cut particle size d₉₈, measured by the sedimentation method, of ≤9 μm of the surface-treated filler material product of the present polypropylene-based masterbatch, preferably the other filler is selected from the group comprising carbon black, silica, ground natural calcium carbonate, precipitated calcium carbonate, nanofillers, graphite, clay, talc, diatomaceous earth, barium sulfate, titanium dioxide, wollastonite, and mixtures thereof. Preferably, the polyester fiber composition comprises another filler, such as carbon black, TiO₂, mica, clay, precipitated silica, talc or calcined kaolin.

Preferably, the other filler is present in the polyester fiber composition in a volume ratio with the surface-treated filler material product in the range from 10:90 to 90:10, preferably from 25:75 to 75:25, and more preferably from 40:60 to 60:40, for example 50:50.

If present, the additives are present in the polyester fiber composition in a total amount ranging from 0.01 to 10 wt.-%, based on the total weight of the polyester fiber composition. For example, the additives are present in the polyester fiber composition in a total amount ranging from 0.01 to 8 wt.-%, more preferably from 0.1 to 5 wt.-%, based on the total weight of the polyester fiber composition.

In view of the above, it is to be noted that the present invention also relates to the use of the polypropylene-based masterbatch for polyester fibers. In particular, the polypropylene-based masterbatch for polyester fibers comprises
from 15 to 35 wt.-%, based on the total weight of the polypropylene-based masterbatch, of a propylene polymer having a melt flow rate MFR (230° C., 2.16 kg), measured according to ISO 1133, in the range from 15 to 50 g/10 min, and
from 65 to 85 wt.-%, based on the total weight of the polypropylene-based masterbatch, of a surface-treated filler material product comprising at least one ground calcium carbonate-comprising filler material having
   a weight median particle size d₅₀ in the range from 0.5 to 2.5 μm, measured by the sedimentation method, and
a top cut particle size d₉₈, measured by the sedimentation method, of ≤9 μm,
and the polyester fiber comprises
from 86 to 99.3 wt.-%, preferably from 90 to 96.5 wt.-%, and most preferably from 92 to 94 wt.-%, based on the total weight of the polyester fiber, of a polyester resin having an intrinsic viscosity, measured according to ISO 1628-5, in the range from 0.6 to 0.8 dl/g, and
from 0.7 to 14 wt.-%, preferably from 3.5 to 10 wt.-% and most preferably from 6 to 8 wt.-%, based on the total weight of the polyester fiber, of the polypropylene-based masterbatch.

It is appreciated that the present invention further relates to a polyester nonwoven or filament formed from the polyester fiber composition as defined herein.

It is appreciated that the term “fiber” refers to a product that is significantly longer than it is wide. Thus, a fibre typically has a specific length. It is to be noted that the length and denier of the fiber depends on the product to be prepared and the skilled person will adapt them according to the specific needs. For example, the fiber can have a length ranging from 10 to 150 mm, preferably from 20 to 120 mm. Additionally or alternatively, the fiber can have a denier per fiber, dpf, ranging from 0.1 to 25 dpf, preferably from 0.2 to 20 dpf. The fiber can be also in the form of a “filament”, which is a continuous, endless fibre. Such filament thus preferably has a denier ranging from 0.1 to 25 dpf, preferably from 0.2 to 20 dpf. The unit “dpf” means denier per fiber.

Contrary thereto, a “nonwoven” refers to a product that is created by bonding or felting polyester fibers together through mechanical, heat and/or chemical processes, rather than weaving them together like traditional fabrics.

The polyester nonwoven or filament may be prepared by any method known to the skilled person. A suitable process for preparing the polyester nonwoven or filament comprises the steps of
a) providing a polyester resin in an amount ranging from 86 to 99.3 wt.-%, preferably from 90 to 96.5 wt.-%, and most preferably from 92 to 94 wt.-%, based on the total weight of the polyester product, the polyester resin having an intrinsic viscosity, measured according to ISO 1628-5, in the range from 0.6 to 0.8 dl/g,
b) providing a polypropylene-based masterbatch in an amount ranging from 0.7 to 14 wt.-%, preferably from 3.5 to 10 wt.-% and most preferably from 6 to 8 wt.-%, based on the total weight of the polyester product,
c) contacting the polyester resin of step a) and the polypropylene-based masterbatch of step b) for obtaining a polyester fiber composition, and
d) forming the polyester fiber composition obtained in step c) such that a polyester nonwoven or filament is obtained.

In one embodiment, the polyester nonwoven or filament further comprises additive(s). The process thus comprises a further step of providing one or more additive(s) selected from the group comprising colouring pigments, fibers, e.g. cellulose, glass or wood fibers, dyes, waxes, lubricants, oxidative- and/or UV-stabilizers, antioxidants and other fillers, such as carbon black, TiO₂, mica, clay, precipitated silica, talc or calcined kaolin.

The one or more additive(s) are preferably added in process step c), whereby the polyester resin of step a), the polypropylene-based masterbatch of step b) and the one or more additives(s) are contacted in any order.

According to step c) of the inventive process, the components of step a) and step b) are contacted in any order. Preferably, the contacting in step c) is carried out by mixing and/or extruding the components to form a mixture. During contacting step c), optionally one or more additives may be added to the mixture as described hereinabove.

In one embodiment, in contacting step c) firstly the polyester resin of step a) is provided and the polypropylene-based masterbatch of step b) is then added under mixing in one or more steps to the polyester resin. Preferably, the polyester resin of step a) and the polypropylene-based masterbatch of step b) are added simultaneously and mixed and/or extruded.

If present, the one or more additive(s) is/are mixed subsequently or simultaneously, preferably simultaneously, with the polypropylene-based masterbatch and/or the polyester resin.

Contacting step c) may be performed by any means known to the skilled person, including, but not limited to, blending, extruding, kneading, and high-speed mixing, preferably extruding.

Preferably, contacting step c) is performed in an internal mixer and/or external mixer, wherein the external mixer preferably is a cylinder mixer. In a preferred embodiment, contacting step c) is performed in an extruder via melt extrusion. It is appreciated that step c) is preferably carried out at a melt temperature of at least 2° C., preferably at least 5° C. and most preferably at least 10° C. above the melting point of the polyester resin. For example, step c) is carried out at a melt temperature of 2° C. to 30° C., preferably of 5° C. to 25° C., and most preferably 10° C. to 20° C., above the melting point of the polyester resin.

The mixture of step c) is formed to a polyester nonwoven or filament in step d). The forming may be performed by any method known to the skilled person resulting in a polyester nonwoven or filament. These methods include, without being limited to, extrusion processes, co-extrusion process, spunbonding-processes, fiber-spinning processes and staple fiber production processes. For example, forming step d) is carried out via a spinneret.

Preferably, contacting step c) is carried out before forming step d). More preferably, contacting step c) is carried out by extruding the polyester resin of step a) and the polypropylene-based masterbatch of step b) to form the polyester fiber composition and then forming the polyester fiber composition in step d) via a spinneret to the polyester nonwoven or filament.

It is appreciated that the process may comprise further steps such as processing the polyester nonwoven or filament in any desired article. Such steps of processing are well known to the skilled person and depend on the article to be prepared and can be adapted by the skilled person accordingly.

In another aspect, the present invention thus relates to an article formed from the polyester nonwoven or filament. Preferably the article is selected from the group comprising hygiene products, medical and healthcare products, wipes such as refreshing wipes or cleaning wipes, tissue products, upholstery, geotextile products, filter products, agriculture and horticulture products, clothing, footwear and baggage products, household and industrial products, packaging products, construction products, automotive parts, bottles, cups, and the like.

In another aspect, the present invention relates to the use of a polypropylene-based masterbatch in the production of a polyester nonwoven or filament, wherein the polypropylene-based masterbatch comprises
a) from 15 to 35 wt.-%, based on the total weight of the polypropylene-based masterbatch, of a propylene polymer having a melt flow rate MFR (230° C., 2.16 kg), measured according to ISO 1133, in the range from 15 to 50 g/10 min, and
b) from 65 to 85 wt.-%, based on the total weight of the polypropylene-based masterbatch, of a surface-treated filler material product comprising at least one ground calcium carbonate-comprising filler material having
   a weight median particle size d₅₀, measured by the sedimentation method, in the range from 0.5 to 2.5 μm, and
   a top cut particle size d₉₈, measured by the sedimentation method, of ≤9 μm.

The scope and interest of the invention will be better understood based on the following examples which are intended to illustrate certain embodiments of the present invention and are non-limitative.

### BRIEF DESCRIPTION OF THE FIGURES

FIG. 1 shows a sketch of a fiber line.

The scope and interest of the invention will be better understood based on the following examples which are intended to illustrate certain embodiments of the present invention and are non-limitative.

### EXAMPLES

### 1. Measurement Methods

In the following, measurement methods implemented in the examples are described.

### Particle Size Distribution

The weight median particle size d₅₀(wt) and weight top cut particle size d₉₈(wt) is determined by the sedimentation method, which is an analysis of sedimentation behaviour in a gravimetric field. The measurement is made with a Sedigraph™ 5120, Micromeritics Instrument Corporation. The method and the instrument are known to the skilled person and are commonly used to determine grain size of fillers and pigments. The measurement is carried out in an aqueous solution of 0.1 wt.-% Na₄P₂O₇. The samples were dispersed using a high speed stirrer and sonicated.

The processes and instruments are known to the skilled person and are commonly used to determine the particle size of fillers and pigments.

### Specific Surface Area (SSA)

The specific surface area was measured via the BET method according to ISO 9277:2010 using nitrogen as adsorbing gas on a Micromeritics ASAP 2460 instrument from Micromeritics. The samples were pretreated in vacuum (10⁻⁵ bar) by heating at 150° C. for a period of 60 min prior to measurement.

### Amount of Surface-Treatment Layer

The amount of the treatment layer on the calcium carbonate-comprising material is calculated theoretically from the values of the BET of the untreated calcium carbonate-comprising material and the amount of the one or more compound(s) that is/are used for the surface-treatment. It is assumed that 100% of the one or more compound(s) are present as surface treatment layer on the surface of the calcium carbonate-comprising material.

### Molecular Weight

The number-average molecular weight Mₙ is measured by gel permeation chromatography, according to ISO 16014-1:2019 and ISO 16014-2/2019.

### Melt Flow Rate

The “melt flow rate” was measured on a CEAST Melt Flow modular line instrument from Instron. The instruments and the measuring method are known to the skilled person. The melt flow rate was measured according to DIN EN ISO 1133-1:2011 by using procedure A. The polymer samples to be measured were in the form of granules or pellets with a length of 1 mm to 5 mm. An amount between 6 to 9 g was used for the measurements. Measurement of the samples was made at 210° C. with a nominal load of 2.16 kg using a capillary die having an inner diameter of 2.095 mm and a length of 8.00 mm. The preheating without load was performed for 300 seconds and the measure length is 20 mm.

The melt flow rate was obtained under standard conditions. The term “standard conditions” according to the present invention refers to standard ambient temperature and pressure (SATP) which refers to a temperature of 298.15 K (25° C.) and an absolute pressure of exactly 100000 Pa (1 bar, 14.5 psi, 0.98692 atm). All measurements were performed on samples that have been stored under similar conditions after preparation.

### Moisture Content

The moisture content was determined according to ISO 787/2.

### Dtex

The dtex value was measured according to EN ISO 2062 and corresponds to the weight in grams of 10 000 m yarn. A sample of 100 metres was wound up on a standard Rycobel electronic wrap wheel under a pretension of 0.5 cN/tex and weighted on analytical scale (Mettler Toledo balance). The grams per 10 000 m yarn length were then calculated.

### Fibre Tenacity and Elongation

Fibre tenacity and elongation were measured according to ISO 2062:1993 on a Statimat ME+ equipment from Textechno. The equipment has a load cell of 10 ON. The distance between the clamps is 250 mm. The analysis speed is 250 mm/min and the analysis is stopped when all 36 fibers break. The tenacity was calculated from the breaking force and the dTex, and expressed in centi Newton per dtex [cN/dtex]. The elongation is the increase of the length produced by stretching a yarn to its maximal load and is expressed as a percentage [%] of its initial length.

### 2. Description of Masterbatches (MB) Preparation:

The masterbatches set out in table 1 have been prepared.

TABLE 1
Masterbatch formulations:

| | Polymer | CaCO₃ |
|---|---|---|
| PET MB | 50% NeoPet80 PET | 50% GCC1 |
| PP MB | 30% Borealis HG475 FB (hPP MFR 27) | 70% GCC1 |
| PE MB | 30% Aspun 6834 (LLDPE MI 17) | 70% GCC1 |
| EMA MB | 30% Elvaloy AC 12024S (EMA MI 20) | 70% GCC1 |

Borealis HG475 FB is a homopolymer polypropylene grade sold by Borealis. It has a melt flow rate, measured at 2.16 kg and 230° C. according to ISO 1133-1, of 27 g/10 min and a density of 0.905 g/cm³ measured by ISO 1183-1.
Aspun™ 6834 is a linear low density polyethylene grade sold by Dow Chemical. It has a melt index, measured at 2.16 kg and 190° C. according to ISO 1133, of 17 g/10 min. It has a density of 0.95 g/cm³ measured according to ASTM D792.
Elvaloy™ AC 12024S is an ethylene methacrylic acid copolymer sold by Dow Chemical. It has a melt index, measured at 2.16 kg and 190° C. according to ASTM D1238, of 20 g/10 min. It has a density of 0.944 g/cm³ measured according to ASTM D792.
NeoPET80 is a food grade PET copolyester grade sold by NeoGroup. It has an intrinsic viscosity of 0.8 dl/g measured according to WN-B010-7040 D.
GCC1: Ground calcium carbonate, commercially available from Omya International AG, Switzerland (d₅₀: 1.7 μm; d₉₈: 6 μm), surface-treated with 0.7 wt.-% succinic anhydride (Hydrores AS 1000, commercially available from Kemira Germany GmbH, Germany), based on the total weight of the ground calcium carbonate.

The particle distribution of the calcium carbonate was measured using a Sedigraph 5120 from the company Micromeritics, USA.

The masterbatches (MB) were produced on a Maris twin screw extrusion compounding line. The polymer PET was predried prior processing in an oven at 160° C. for 4 hours.

The settings utilized for the masterbatch production are set out in the following table 2.

TABLE 2
settings for the masterbatch production

| | | | | Vacuum |
|---|---|---|---|---|
| | Melt | Screw | Output | suction |
| | temperature | RPM | kg/h | mbar |
| PET MB | 270° C. | 800 | 13 | 71 |
| PP MB | 220° C. | 800 | 13 | 71 |
| PE MB | 220° C. | 800 | 13 | 71 |
| EMA MB | 220° C. | 800 | 13 | 71 |

### Description of Fiber Production:

The following table 3 shows the fiber formulations.

TABLE 3
Fiber formulations:

| | PET | PET | Masterbatch | Masterbatch | |
|---|---|---|---|---|---|
| | Type | wt % | Type | wt % | Comment |
| # 1 (Baseline) | RT5140 | 100% | — | — | Baseline |
| | | | | | without |
| | | | | | CaCO₃ |
| # 2 - Comparative 1 | RT5140 | 90% | PET MB | 10% | 5% final |
| | | | | | CaCO₃ |
| | | | | | concentration |
| # 3 - Inventive 1 | RT5140 | 93% | PP MB | 7% | 5% final |
| | | | | | CaCO₃ |
| | | | | | concentration |
| # 4 - Comparative 2 | RT5140 | 93% | PE MB | 7% | 5% final |
| | | | | | CaCO₃ |
| | | | | | concentration |
| # 5 - Comparative 3 | RT5140 | 93% | PE MB + | 4.5% + | 5% final |
| | | | EMA MB | 2.5% | CaCO₃ |
| | | | | | concentration |

RT5140 is a polyester grade suitable for fiber spinning and sold by Invista Resins & Fibers GmbH. It has an intrinsic viscosity of 0.65 dl/g measured according to WN-B010-7040 D.

### Processability Results:

Fiber spinning trials were done on a Hills lab scale fiber spinning line. The fiber formulations were dry blended and then extruded.

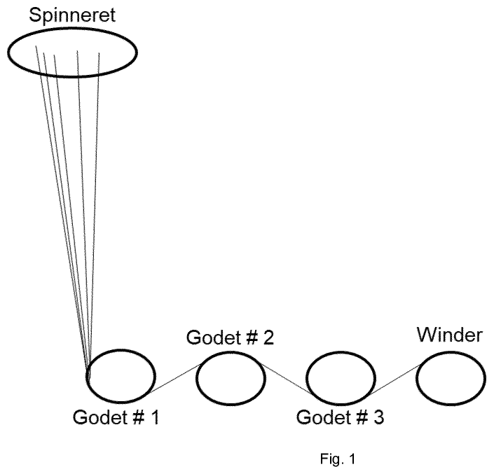

The fiber line is shown in FIG. 1.

The fiber line settings are as follows and are further shown in table 4:
Extruder: 19 mm screw, L/D ratio 30:1

Melt temperature 280° C.
Melt pump set at 0.3 cc/rev
Spinneret with 36 holes

The holes are circular.
Each hole has a diameter of 0.35 mm and an L/D ratio of 4
Output: 0.3 g/hole/min (~0.6 kg/h)
Godet #1:493 m/min and 95° C.
Godet #2:1480 m/min and 90° C.
Godet #3:1490 m/min and 40° C.
Stretch ratio (godet #1 to #2): 3

TABLE 4
fiber line settings

| | melt pump | dTex/ | Max speed m/min |
|---|---|---|---|
| | P (bar) | filament | (spinneret to godet #1) |
| # 1 - Baseline | 45 | 2 | 2400 |
| # 2 - Comparative 1 | 53 | 2.1 | 1900 |
| # 3 - Inventive 1 | 53 | 2.08 | 1900 |
| # 4 - Comparative 2 | 60 | 2.05 | 1600 |
| # 5 - Comparative 3 | 100 | unstable | 900 |

The melt pump pressure was read from the control panel of the Hills fiber line.

The max speed was obtained as follows: Fibers were wound around Godet #1 and speed of Godet #1 increased until melt instability was observed at the spinneret.

### Results Interpretation:

It can be seen that Inventive 1 give a similar processability response as Comparative 1, in terms of melt pump pressure increase and max speed decrease.

Comparative 2 and 3 give worse response than Comparative 1 and Inventive 1, i.e. they show higher increase in melt pump pressure and lower max speed. Since Comparative 2 and 3 are also based on polyolefins, it is surprising that Inventive 1 performs better. Especially the bad result obtained with comparative 3, which contains a compatibilizer typically used in polyolefin-PET blends, is surprising.

The results for the fiber properties are listed in table 5.

TABLE 5
Fiber property results

| | tenacity cN/dTex | Elongation % |
|---|---|---|
| # 1 - Baseline | 3.1 | 30% |
| # 2 - Comparative 1 | 1.9 | 26% |
| # 3 - Inventive 1 | 1.9 | 15% |
| # 4 - Comparative 2 | 2.2 | 10% |
| # 5 - Comparative 3 | High standard | High standard |
| | deviation | deviation |

Inventive example 1 gave similar tenacity and shrinkage than Comparative example 1. The increased loss in elongation could be balanced by improving the annealing step between godet #2 and #3. Comparative example 2 and 3 gave a different balance in tensile properties and, as seen above, worse processability than Inventive example 1. Comparative example 2 also had very high standard deviation on fiber elongation. Comparative example 3 showed very high standard deviation, surely due to the unstable processing reported above.

1-15. (canceled)

16. A polypropylene-based masterbatch comprising from 15 to 35 wt.-%, based on the total weight of the polypropylene-based masterbatch, of a propylene polymer having a melt flow rate MFR (230° C., 2.16 kg), measured according to ISO 1133, in the range from 15 to 50 g/10 min, and
from 65 to 85 wt.-%, based on the total weight of the polypropylene-based masterbatch, of a surface-treated filler material product comprising at least one ground calcium carbonate-comprising filler material having
a weight median particle size d₅₀ in the range from 0.5 to 2.5 μm, measured by the sedimentation method, and
a top cut particle size d₉₈, measured by the sedimentation method, of ≤9 μm.

17. The polypropylene-based masterbatch according to claim 16, wherein the propylene polymer is a random propylene copolymer or a propylene homopolymer, and/or the propylene polymer has
a) a melt flow rate MFR (230° C., 2.16 kg), measured according to ISO 1133, in the range from 20 to 40 g/10 min, and/or
b) a density, measured according to ISO 1183-1, equal or below 0.910 g/cm³.

18. The polypropylene-based masterbatch according to claim 16, wherein the at least one ground calcium carbonate-comprising filler material is selected from the group consisting of marble, chalk, dolomite, limestone, and mixtures thereof.

19. The polypropylene-based masterbatch according to claim 16, wherein the at least one surface-treated ground calcium carbonate-comprising filler material comprises a treatment layer on the surface of the at least one ground calcium carbonate-comprising filler material comprising
i. at least one mono-substituted succinic anhydride consisting of succinic anhydride mono-substituted with a group selected from a linear, branched, aliphatic and cyclic group having a total amount of carbon atoms from at least C2 to C30 in the substituent and/or salts thereof, and/or
ii. at least one saturated or unsaturated aliphatic linear or branched carboxylic acid and/or salts thereof.

20. The polypropylene-based masterbatch according to claim 19, wherein the at least one surface-treated ground calcium carbonate-comprising filler material, has
a weight median particle size d₅₀, measured by the sedimentation method, in the range from 1.0 to 2.2 μm, and
a top cut particle size d₉₈, measured by the sedimentation method, of ≤7.5 μm, and/or
a specific surface area (BET) of from 0.5 to 150 m²/g as measured using nitrogen and the BET method according to ISO 9277:2010, and/or
a moisture, measured according to ISO 787/2, of ≤0.25 wt.-%, based on the total weight of the at least one surface-treated filler material product.

21. The polypropylene-based masterbatch according to claim 16, wherein the at least one surface-treated ground calcium carbonate-comprising filler material, comprises the treatment layer in an amount of from 0.1 to 3 wt.-%, based on the total dry weight of the at least one ground calcium carbonate-comprising filler material.

22. The polypropylene-based masterbatch according to claim 16, wherein the polypropylene-based masterbatch comprises the propylene polymer in an amount ranging from 28 to 32 wt.-%, based on the total weight of the polypropylene-based masterbatch, and the surface-treated filler material product in an amount ranging from 68 to 72 wt.-%, based on the total weight of the polypropylene-based masterbatch.

23. The polypropylene-based masterbatch according to claim 16, wherein the polypropylene-based masterbatch is free of polymeric materials differing from the propylene polymer in an amount of equal to or above 5 wt.-%, based on the total weight of the polypropylene-based masterbatch, and/or the polypropylene-based masterbatch is free of filler materials differing from the surface-treated filler material product, in an amount of equal to or above 5 wt.-%, based on the total weight of the polypropylene-based masterbatch.

24. A polyester fiber composition comprising
from 86 to 99.3 wt.-%, based on the total weight of the polyester fiber composition, of a polyester resin having an intrinsic viscosity, measured according to ISO 1628-5, in the range from 0.6 to 0.8 dl/g, and
from 0.7 to 14 wt.-%, based on the total weight of the polyester fiber composition, of the polypropylene-based masterbatch according to claim 16.

25. The polyester fiber composition according to claim 24, wherein the polyester fiber composition comprises the at least one surface-treated ground calcium carbonate-comprising filler material, in an amount ranging from 0.5 to 10 wt.-%, based on the total weight of the polyester fiber composition.

26. The polyester fiber composition according to claim 24, wherein the polyester resin consists of one or more saturated polyester resin(s) selected from the group consisting of polylactic acid, polylactic acid-based polymer, aliphatic polyester, polyhydroxyalkanoates, polyethylene terephthalate (PET), polybutylene terephthalate (PBT), polybutyrate-adipate-terephthalate (PBAT), polyglycolide, poly(dioxanone) and mixtures thereof.

27. The polyester fiber composition according to claim 24, wherein the polyester resin is polybutylene terephthalate (PBT).

28. A polyester nonwoven or filament formed from the polyester fiber composition according to claim 24.

29. A process for preparing a polyester nonwoven or filament as defined in claim 28, wherein the process comprises the steps of
a) providing a polyester resin in an amount ranging from 86 to 99.3 wt.-%, based on the total weight of the polyester product, the polyester resin having an intrinsic viscosity, measured according to ISO 1628-5, in the range from 0.6 to 0.8 dl/g,
b) providing a polypropylene-based masterbatch in an amount ranging from 0.7 to 14 wt.-%, based on the total weight of the polyester product,
c) contacting the polyester resin of step a) and the polypropylene-based masterbatch of step b) for obtaining a polyester fiber composition, and
d) forming the polyester fiber composition obtained in step c) such that a polyester nonwoven or filament is obtained.

30. A method comprising producing a polyester nonwoven or filament with a polypropylene-based masterbatch, the polypropylene-based masterbatch comprising
a) from 15 to 35 wt.-%, based on the total weight of the polypropylene-based masterbatch, of a propylene polymer having a melt flow rate MFR (230° C., 2.16 kg), measured according to ISO 1133, in the range from 15 to 50 g/10 min, and
b) from 65 to 85 wt.-%, based on the total weight of the polypropylene-based masterbatch, of a surface-treated filler material product comprising at least one ground calcium carbonate-comprising filler material having
a weight median particle size d₅₀, measured by the sedimentation method, in the range from 0.5 to 2.5 μm, and
a top cut particle size d₉₈, measured by the sedimentation method, of ≤9 μm.

31. An article formed from a polyester nonwoven or filament according to claim 28.

32. The article according to claim 31, wherein the article is selected from the group consisting of hygiene products, medical products, healthcare products, wipes, refreshing wipes, cleaning wipes, tissue products, upholstery, geotextile products, filter products, agriculture products, horticulture products, clothing, footwear products, baggage products, household products, industrial products, packaging products, construction products, automotive parts, bottles, and cups.
